(19) United States
(12) Patent Application Publication
(10) Pub. No.: US 2019/0124676 A1
(43) Pub. Date: Apr. 25, 2019

(54) NARROWBAND NETWORK BASE STATION AND MOBILE STATION DATA TRANSMISSION SCHEDULING METHOD THEREOF

(71) Applicant: Institute For Information Industry, Taipei (TW)

(72) Inventors: Ya-Ju YU, Kaohsiung City (TW); Sheng-Chia TSENG, Chiayi City (TW); Yong-Shin HUANG, Chiayi County (TW); Li WAN, Taipei City (TW)

(21) Appl. No.: 15/816,994

(22) Filed: Nov. 17, 2017

(30) Foreign Application Priority Data
Oct. 23, 2017 (TW) 106136347

(51) Int. Cl. H04W 72/12; H04W 72/04

(52) U.S. Cl. CPC H04W 72/1273; H04W 16/14; H04W 72/0446

(57) ABSTRACT

A narrowband network base station and a mobile station data transmission scheduling method thereof are provided. Within a control channel period, the narrowband network base station selects a first candidate unit which corresponds to a first shared channel initial subframe within a shared channel period while the first shared channel initial subframe is closest to an initial subframe of the shared channel period. The narrowband network base station determines a plurality of first data transmission units based on distances between the first shared channel initial subframe and different shared channel initial subframes. The narrowband network base station selects a second data transmission unit from the first data transmission units while the second data transmission unit corresponds to an under-transmission data amount of a first mobile station, and allocates the first candidate unit and the second data transmission unit to the first mobile station.

### PRIORITY

This application claims priority to Taiwan Patent Application No. 106136347 filed on Oct. 23, 2017, which are hereby incorporated by reference in its entirety.

### FIELD

The present invention relates to a narrowband network base station and a mobile station data transmission scheduling method thereof. More particularly, the present invention relates to a narrowband network base station for optimizing data transmission scheduling and a mobile station data transmission scheduling method thereof.

### BACKGROUND

In a narrowband network system, a base station performs data transmission scheduling for mobile stations in the network within a data processing period. The data processing period comprises a control channel period and a shared channel period. The base station is mainly configured to transmit control messages to the mobile stations within the control channel period and transmit data to the mobile stations within the shared channel period.

Further speaking, the control channel period comprises a plurality of candidate units, and each of the candidate units has a respective data transmission unit corresponding to the shared channel period. The base station is mainly configured to transmit a control message to a mobile station via a single candidate unit, thereby notifying the mobile station to transmit data in a corresponding data transmission unit.

In the conventional narrowband network system, when the base station is going to allocate relevant data transmission resources to the mobile stations, the base station allocates resources to the mobile stations sequentially according to a connection sequence of the mobile stations, and the base station also allocates the candidate units and the corresponding data transmission units to the mobile stations sequentially according to a sequence of the candidate units. However, this allocation mode will cause excessive waste of network resources.

Specifically, in the currently existing narrowband network system, the base station mainly decides a corresponding data transmission unit for each of different candidate units according to various network parameters (e.g., schedule delay parameters k₀). However, sometimes the data transmission unit corresponding to the candidate unit with a higher priority in terms of sequence may not be scheduled at the beginning of the shared channel period because of different setting of the network parameters, and this will possibly cause the waste of resources.

Furthermore, for a specific mobile station with a large amount of under-transmission data, if the candidate unit and the corresponding data transmission unit are directly allocated to the specific mobile station in a certain sequence in the case where no planning is performed on the scheduling in the aforesaid conventional narrowband network system, then the large amount of under-transmission data of the specific mobile station may unnecessarily use additional data transmission units, and this also causes the waste of resources.

Accordingly, an urgent need exists in the art to improve the problem of waste of network resources in the conventional narrowband network system.

### SUMMARY

An objective of the present invention is to provide mobile station data transmission scheduling for a narrowband network base station. The narrowband network base station performs data scheduling for a data processing period. The data processing period comprises a control channel period and a shared channel period. The control channel period comprises a plurality of candidate units, and the shared channel period comprises a plurality of shared channel subframes.

The disclosure includes a mobile station data transmission scheduling method, comprising: determining, by the narrowband network base station, a plurality of shared channel initial subframes corresponding to the candidate units; selecting, by the narrowband network base station, a first candidate unit from the candidate units, wherein the shared channel initial subframes include a first shared channel initial subframe corresponding to the first candidate unit, and the first shared channel initial subframe has the shortest distance to an initial subframe of the shared channel period.

The mobile station data transmission scheduling method can further comprise: deciding, by the narrowband network base station, a plurality of first data transmission units according to a plurality of distances between the first shared channel initial subframe and the shared channel initial subframes; receiving, by the narrowband network base station, a plurality of pieces of data amount information from a plurality of mobile stations; and calculating, by the narrowband network base station, a plurality of under-transmission data amounts of the plurality of mobile stations according to the plurality of pieces of data amount information.

The mobile station data transmission scheduling method can further comprise: selecting, by the narrowband network base station, a first under-transmission data amount of a first mobile station from the under-transmission data amounts according to the first data transmission units, wherein the first under-transmission data amount has the minimum difference from a data amount capable of being transmitted by a second data transmission unit among the plurality of first data transmission units; and allocating, by the narrowband network base station, the first candidate unit and the second data transmission unit to the first mobile station.

The disclosure also includes a narrowband network base station that performs data scheduling for a data processing period. The data processing period comprises a control channel period and a shared channel period. The control channel period comprises a plurality of candidate units, and the shared channel period comprises a plurality of shared channel subframes.

The narrowband network base station comprises a processor and a transceiver. The processor is configured to: determine a plurality of shared channel initial subframes corresponding to the candidate units; select a first candidate unit from the candidate units, wherein the shared channel initial subframes include a first shared channel initial subframe corresponding to the first candidate unit, and the first shared channel initial subframe has the shortest distance to an initial subframe of the shared channel period.

The processor can be further configured to: decide a plurality of first data transmission units according to a plurality of distances between the first shared channel initial subframe and the shared channel initial subframes; receive a plurality of pieces of data amount information from a plurality of mobile stations via the transceiver; and calculate a plurality of under-transmission data amounts of the plurality of mobile stations according to the plurality of pieces of data amount information.

The processor can be further configured to: select a first under-transmission data amount of a first mobile station from the under-transmission data amounts according to the first data transmission units, wherein the first under-transmission data amount has the minimum difference from a data amount capable of being transmitted by a second data transmission unit among the plurality of first data transmission units; and allocate the first candidate unit and the second data transmission unit to the first mobile station via the transceiver.

### BRIEF DESCRIPTION OF THE DRAWINGS

FIG. 1A is a schematic view of a narrowband network system according to a first embodiment of the present invention;

FIG. 1B is a block diagram of a narrowband network base station according to the first embodiment of the present invention;

FIG. 1C to FIG. 1E are schematic views illustrating the narrowband network base station performing data scheduling for a data processing period according to the first embodiment of the present invention;

FIG. 2A to FIG. 2F are schematic views illustrating a narrowband network base station performing data scheduling for a data processing period according to a second embodiment of the present invention;

FIG. 3A to FIG. 3E are schematic views illustrating a narrowband network base station performing data scheduling for a data processing period according to a third embodiment of the present invention;

FIG. 4 is a flowchart diagram of a mobile station data transmission scheduling method according to a fourth embodiment of the present invention; and

FIG. 5A to FIG. 5B are flowchart diagrams of a mobile station data transmission scheduling method according to a fifth embodiment of the present invention.

### DETAILED DESCRIPTION

In the following description, the present invention will be explained with reference to certain example embodiments thereof. However, these example embodiments are not intended to limit the present invention to any specific example, embodiment, environment, applications or implementations described in these embodiments. Therefore, description of these embodiments is only for purpose of illustration rather than to limit the present invention. In the following embodiments and the attached drawings, elements unrelated to the present invention are omitted from depiction; and dimensional relationships among individual elements in the attached drawings are illustrated only for ease of understanding, but not to limit the actual scale.

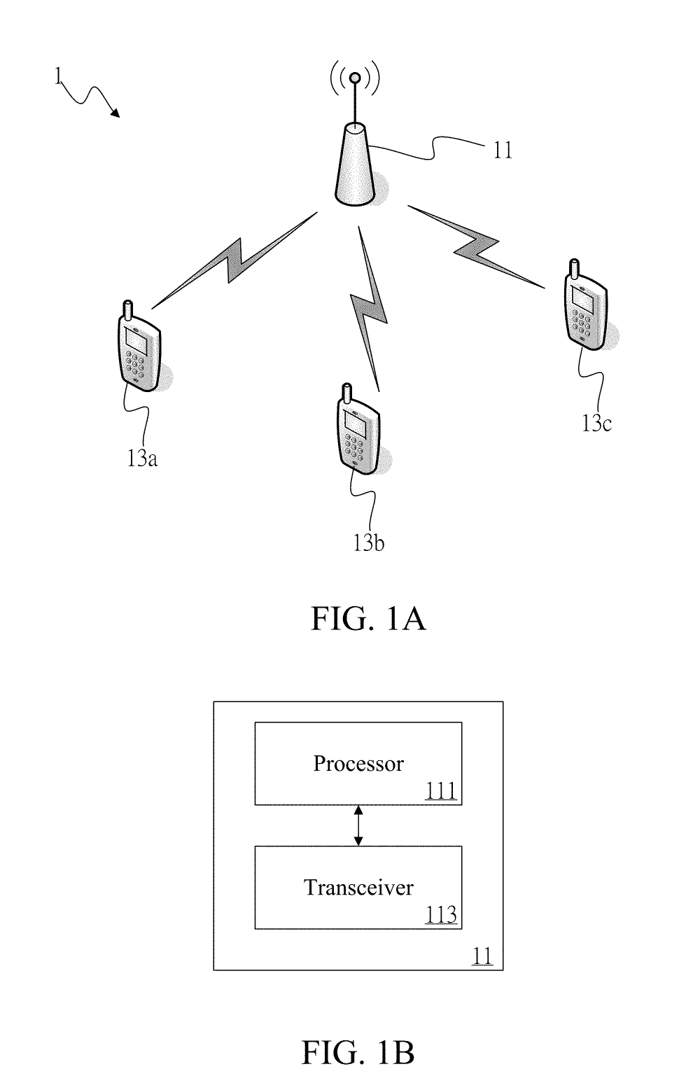

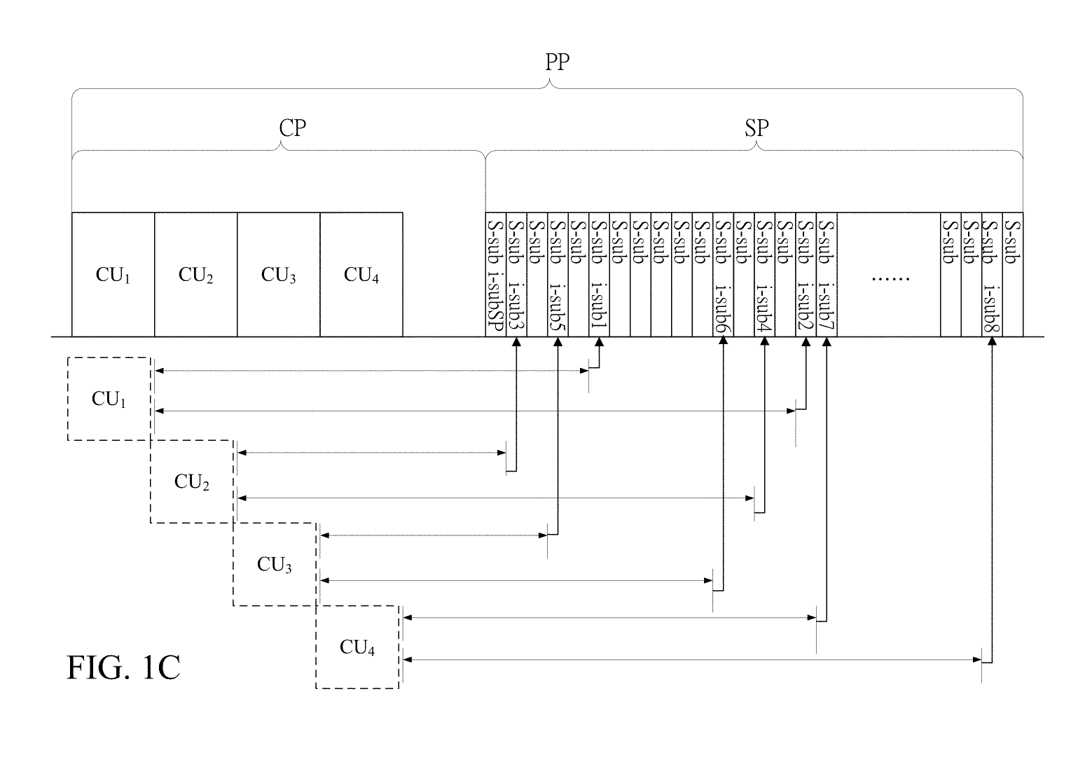

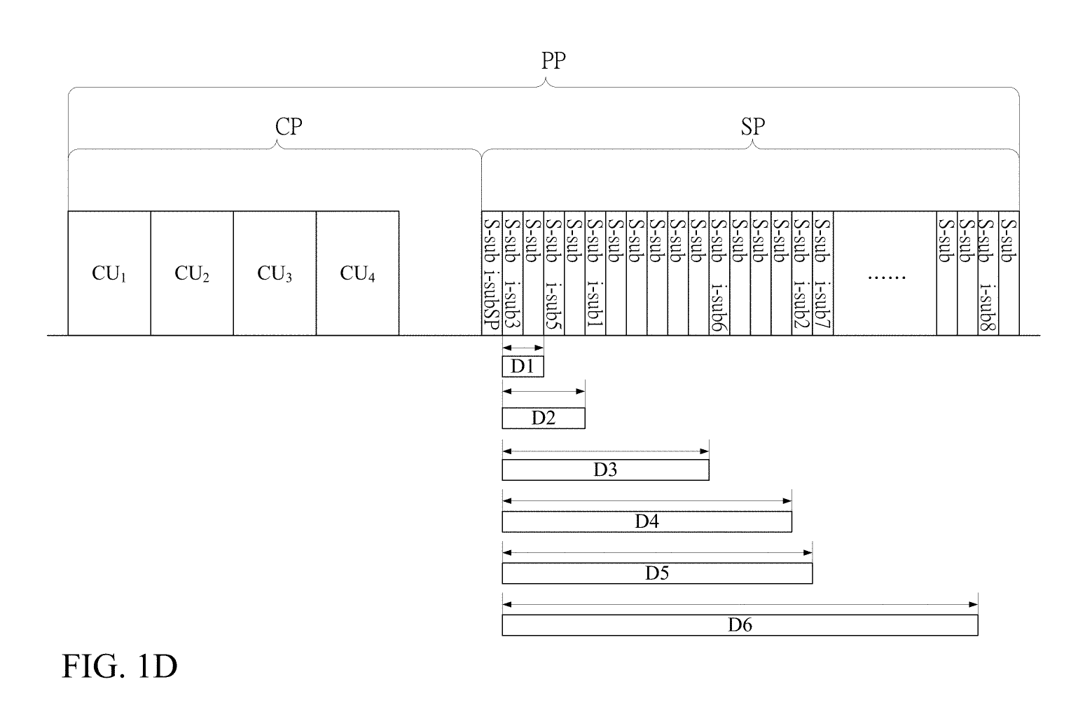

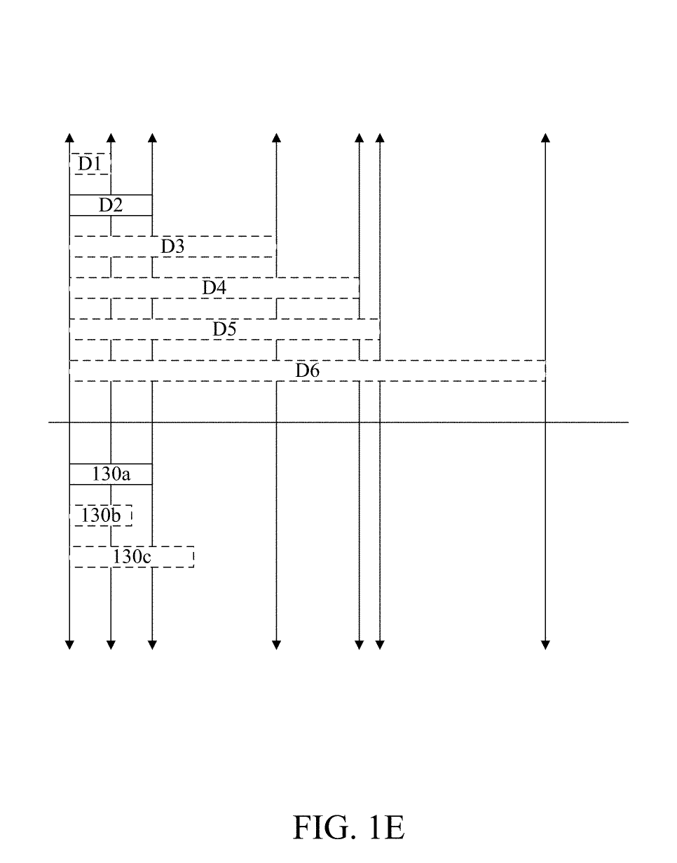

Please refer to FIG. 1A and FIG. 1B. FIG. 1A is a schematic view of a narrowband network system 1 according to a first embodiment of the present invention. The narrowband network system 1 comprises a narrowband network base station 11 and a plurality of mobile stations 13a to 13c. FIG. 1B is a block diagram of a narrowband network base station 11 according to the first embodiment of the present invention. The narrowband network base station 11 comprises a processor 111 and a transceiver 113. The aforesaid elements are electrically connected, and interaction among these elements will be further described hereinafter.

Please refer to FIG. 1C to FIG. 1E together, which are schematic views illustrating the narrowband network base station 11 performing data scheduling for a data processing period PP according to the first embodiment of the present invention. The data processing period PP comprises a control channel period CP and a shared channel period SP. The control channel period CP comprises a plurality of candidate units CU₁ to CU₄, and the shared channel period SP comprises a plurality of shared channel subframes S-sub.

First, the processor 111 of the narrowband network base station 11 determines a plurality of shared channel initial subframes i-sub corresponding to the candidate units CU₁ to CU₄. Specifically, one candidate unit may correspond to a plurality of shared channel initial subframes according to different network setting parameters (e.g., schedule delay parameters). Therefore, the processor 111 of the narrowband network base station 11 may respectively determine a plurality of shared channel initial subframes corresponding to each of the candidate units CU₁ to CU₄.

As shown in FIG. 1C, in the first embodiment, the processor 111 of the narrowband network base station 11 determines based on network setting parameters that: the candidate unit CU₁ may correspond to two shared channel initial subframes i-sub1 to i-sub2; the candidate unit CU₂ may correspond to two shared channel initial subframes i-sub3 to i-sub4; the candidate unit CU₃ may correspond to two shared channel initial subframes i-sub5 to i-sub6; and the candidate unit CU₄ may correspond to two shared channel initial subframes i-sub7 to i-sub8.

Next, the processor 111 of the narrowband base station 11 selects the candidate unit CU₂ from the candidate units CU₁ to CU₄ as a first candidate unit. The processor 111 selecting the candidate unit CU₂ as the first candidate unit is based on the fact that: the first shared channel initial subframe i-sub3 of the candidate unit CU₂ has the shortest distance to an initial subframe i-subSP of the shared channel period SP.

In other words, in the first embodiment, the processor 111 of the narrowband base station 11 selects the candidate unit CU₂ as the first candidate unit because the first shared channel initial subframe i-sub3 has the shortest distance to the initial subframe i-subSP of the shared channel period SP, as shown in FIG. 1C.

Thereafter, referring to FIG. 1D, the processor 111 of the narrowband base station 11 decides a plurality of data transmission units D1 to D6 according to a plurality of distances between the first shared channel initial subframe i-sub3 of the candidate unit CU₂ and the shared channel initial subframes i-sub1 to i-sub2, i-sub5 to i-sub6, i-sub7 to i-sub8 respectively of other candidate units CU₁, CU₃ and CU₄.

Next, the processor 111 of the narrowband network base station 11 first calculates a plurality of under-transmission data amounts 130a to 130c (uplink or downlink) of a plurality of mobile stations 13a to 13c, and then the processor 111 selects the under-transmission data amount 130a of the mobile station 13a from the under-transmission data amounts 130a to 130c according to the size of the data transmission units D1 to D6. In detail, referring to FIG. 1E together, the processor 111 of the narrowband network base station 11 selecting the under-transmission data amount 130a is based on the fact that: the under-transmission data amount 130a has the minimum difference from a data amount capable of being transmitted by the data transmission unit D2.

Obviously, since the use of i-sub3 can minimize the waste of resources of the front-end shared subframe S-sub, and transmitting the under-transmission data amount 130a of the mobile station 13a using the data transmission unit D2 is most efficient, the processor 111 of narrowband network base station 11 may allocate the candidate unit CU₂ and the data transmission unit D2 to the mobile station 13a via the transceiver 113. In this way, the utilization ratio of resources can be maximized by performing allocation after performing determination in advance.

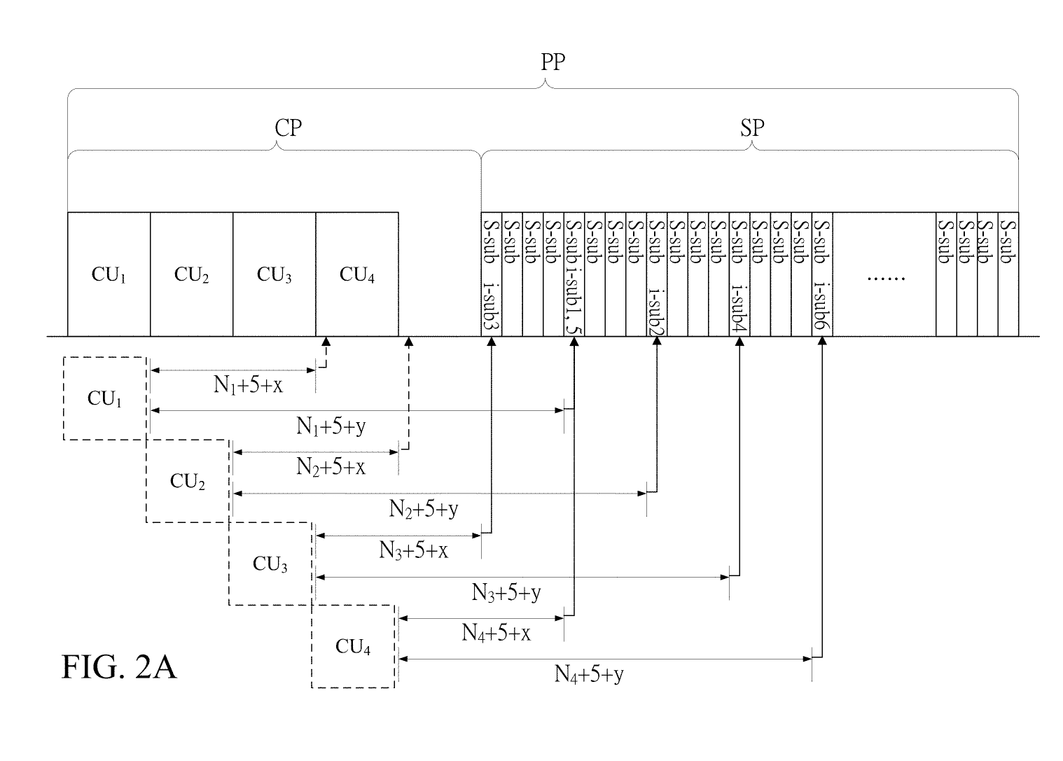

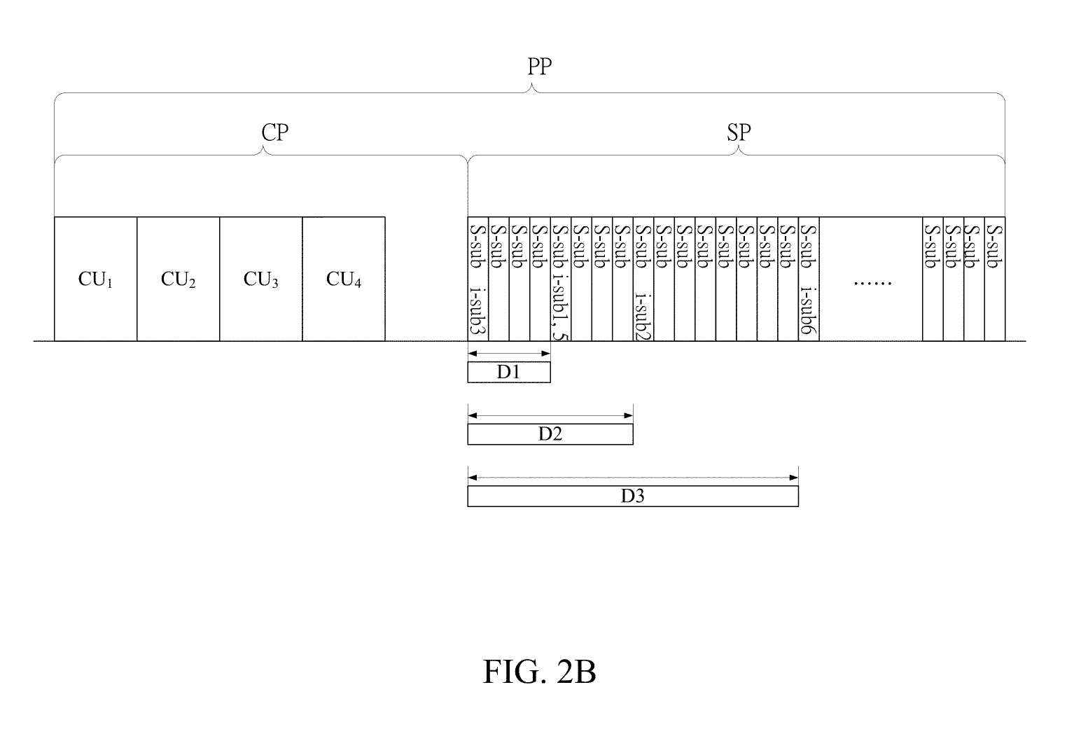

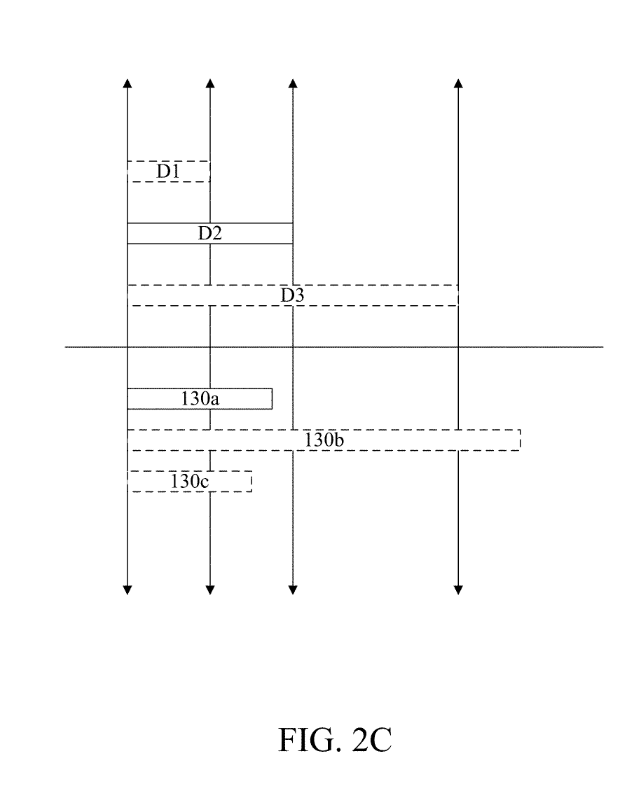

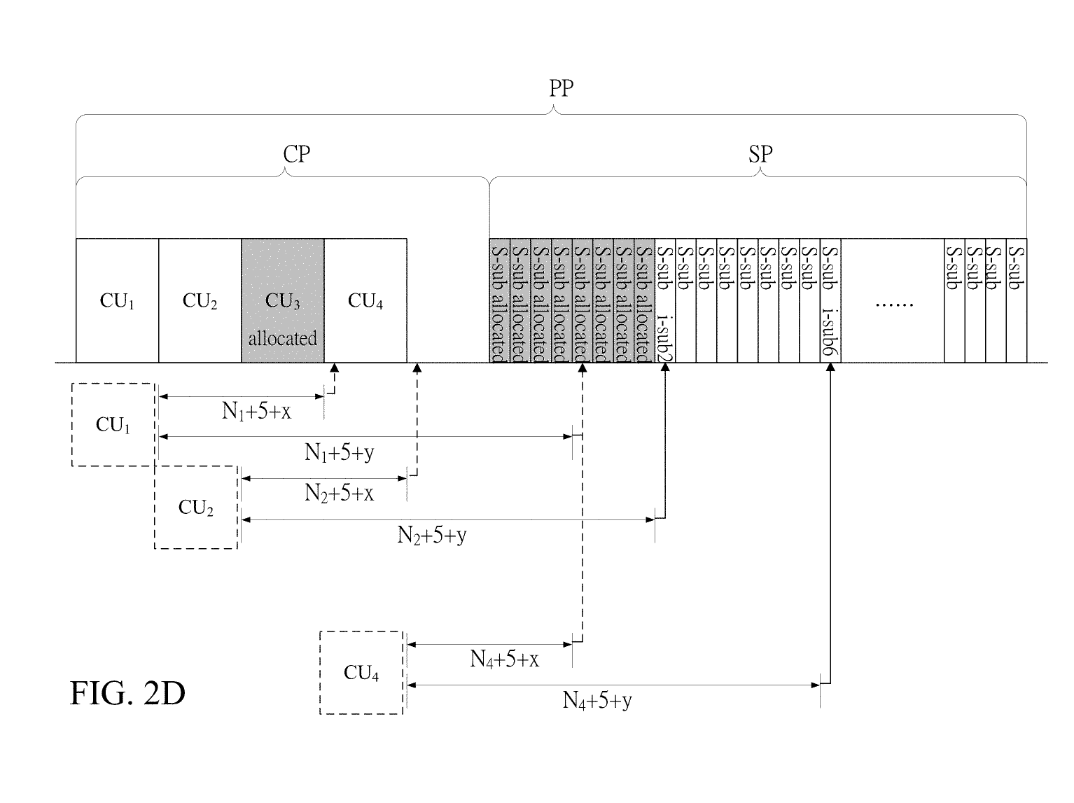

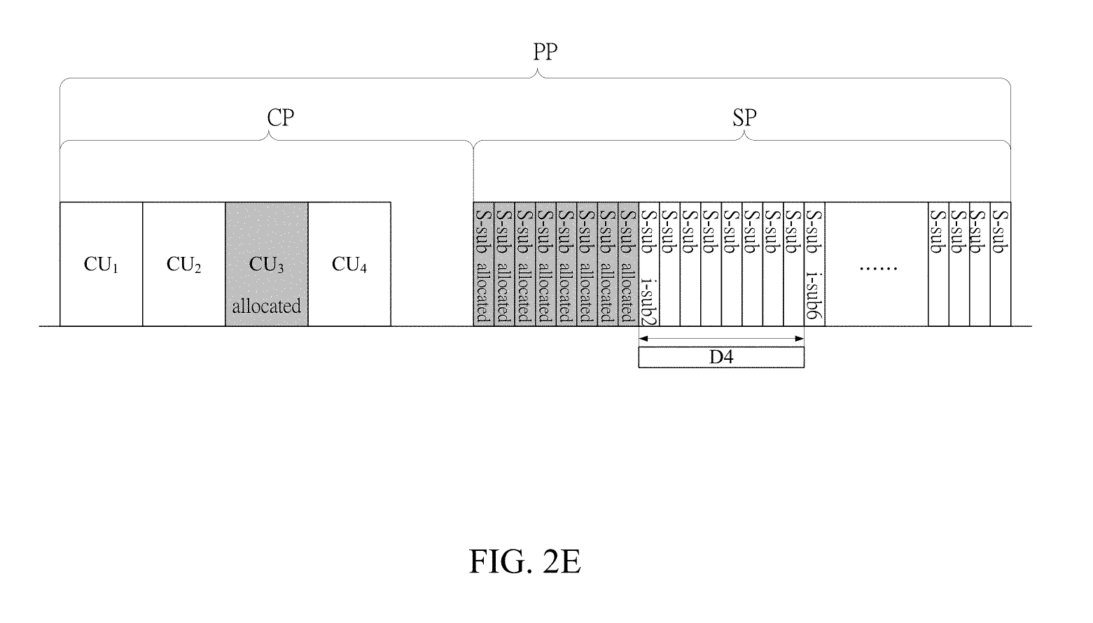

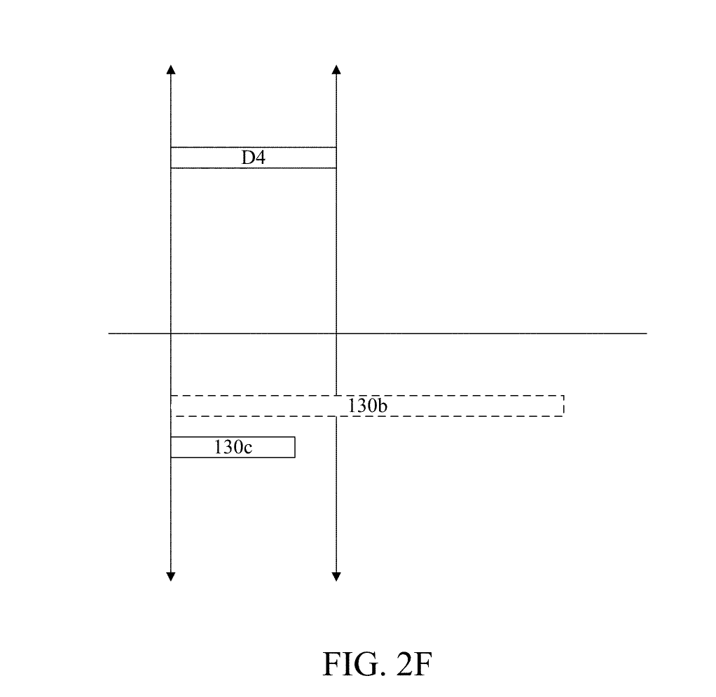

Please refer to FIG. 2A to FIG. 2F, which are schematic views illustrating the narrowband network base station 11 performing data scheduling for a data processing period PP according to a second embodiment of the present invention. The network architecture of the second embodiment is similar to that of the first embodiment, so elements with same symbols have same functions and will not be further described herein. The second embodiment mainly applies the narrowband network base station to Narrowband Internet of Things (NB-IoT), and further illustrates details of data scheduling performed by the narrowband base station of the present invention.

Similarly, the processor 111 of the narrowband network base station 11 first determines a plurality of shared channel initial subframes i-sub corresponding to the candidate units CU₁ to CU₄. In the second embodiment, the network setting parameters are mainly schedule delay parameters k₀ used in the NB-IoT network, and k₀ has two kinds of values x and y. Accordingly, the processor 111 of the narrowband network base station 11 may determine a plurality of shared channel initial subframes corresponding to each of the candidate units CU₁ to CU₄ based on the schedule delay parameters k₀.

In the second embodiment, a single candidate unit and a single schedule delay parameter correspond to a single shared channel initial subframe. Accordingly, as shown in FIG. 2A, the processor 111 of the narrowband network base station 11 determines based on the schedule delay parameters k₀ that: the candidate unit CU₁ may correspond to one shared channel initial subframe i-sub1; the candidate unit CU₂ may correspond to one shared channel initial subframe i-sub2; the candidate unit CU₃ may correspond to two shared channel initial subframes i-sub3 to i-sub4; and the candidate unit CU₄ may correspond to two shared channel initial subframes i-sub5 to i-sub6.

It shall be particularly appreciated that, since the second embodiment is applied in the NB-IoT, the shared channel initial subframes are mainly determined according to network parameters of the NB-IoT. For example, taking the candidate unit CU₁ as an example, N1 represents a subframe position before the end of the candidate unit CU₁, 5 represents a preset fixed parameter, and x and y are respectively different schedule delay parameters k₀, as shown in FIG. 2A.

Accordingly, since N₁+5+x does not reach the subframe of the shared channel period, it is discarded and not used. On the other hand, N₁+5+y reaches the subframe of the shared channel period, so it is set to be i-sub1. Similarly, for the candidate unit CU₂, N₂ represents a subframe position before the end of the candidate unit CU₂. Accordingly, since N₂+5+x does not reach the subframe of the shared channel period either, it is discarded and not used. On the other hand, N₂+5+y reaches the subframe of the shared channel period, so it is set to be i-sub2.

Similarly, for the candidate unit CU₃, N₃ represents a subframe position before the end of the candidate unit CU₃. Accordingly, since N₃+5+x reaches the subframe of the shared channel period either, it is set to be i-sub3. On the other hand, N₃+5+y reaches the subframe of the shared channel period, so it is set to be i-sub4.

For the candidate unit CU₄, N₄ represents a subframe position before the end of the candidate unit CU₄. Accordingly, since N₄+5+x reaches the subframe of the shared channel period either, it is set to be i-sub5 (which is the same subframe as the i-sub1). On the other hand, N₄+5+y reaches the subframe of the shared channel period, so it is set to be i-sub6.

Next, the processor 111 of the narrowband network base station 11 selects the candidate unit CU₃ as the first candidate unit from the candidate units CU₁ to CU₄ because the first shared channel initial subframe i-sub3 of the candidate unit CU₃ has the shortest distance to an initial subframe of the shared channel period SP (i.e., the first shared channel initial subframe i-sub3 is the same subframe as the initial subframe in the second embodiment).

Thereafter, referring to FIG. 2B, the processor 111 of the narrowband base station 11 decides a plurality of data transmission units D1 to D3 according to a plurality of distances between the shared channel initial subframe i-sub3 of the candidate unit CU₃ and the shared channel initial subframes i-sub1 to i-sub2, i-sub5 to i-sub6 of other candidate units CU₁, CU₂ and CU₄.

Next, the processor 111 of the narrowband base station 11 first calculates a plurality of under-transmission data amounts 130a to 130c (uplink or downlink) of a plurality of mobile stations 13a to 13c. In detail, the under-transmission data amounts are mainly calculated by the processor 111 according to the under-transmission data and the number of re-transmissions of each of the mobile stations. For example, the under-transmission data amount 130a of the mobile station 13a is mainly calculated through multiplying the under-transmission data of the mobile station 13a by the number of re-transmissions of the mobile station 13a.

Then, the processor 111 selects the under-transmission data amount 130a of the mobile station 13a from the under-transmission data amounts 130a to 130c according to the sizes of the data transmission units D1 to D3. In detail, referring to FIG. 2C together, the processor 111 of the narrowband network base station 11 selecting the under-transmission data amount 130a is based on the fact that: the under-transmission data amount 130a has the minimum difference from a data amount capable of being transmitted by the data transmission unit D2.

Similarly, since the use of i-sub3 can minimize the waste of resources of the front-end shared subframe S-sub, and transmitting the under-transmission data amount 130a of the mobile station 13a using the data transmission unit D2 is most efficient, the processor 111 of narrowband network base station 11 may then allocate the candidate unit CU₃ and the data transmission unit D2 to the mobile station 13a via the transceiver 113.

Next, in the second embodiment, the narrowband network base station 11 further performs allocation on the remaining candidate units and network resources. Referring to FIG. 2D, the processor 111 of the narrowband network base station 11 selects a candidate unit from the remaining candidate units CU₁, CU₂ and CU₄. Specifically, because the data transmission unit D2 has been allocated to the mobile station 13a, the subframes occupied by the data transmission unit D2 cannot be used. Therefore, the processor 111 of the narrowband network base station 11 first determines which one among the remaining shared channel initial subframes (i.e., i-sub2 and i-sub6) has the shortest distance to an end subframe of the data transmission unit D2.

In the second embodiment, as shown in FIG. 2D, the processor 111 of the narrowband network base station 11 selects the candidate unit CU₂ corresponding to the shared channel initial subframe i-sub2 as the second candidate unit because the shared channel initial subframe i-sub2 has the shortest distance to the end subframe of the data transmission unit D2. Similarly, the processor 111 of the narrowband network base station 11 decides a data transmission unit D4 according to a distance between the shared channel initial subframe i-sub2 and the remaining shared channel initial subframe i-sub6.

Then, the processor 111 selects the under-transmission data amount 130c of the mobile station 13c from the under-transmission data amounts 130b to 130c according to the size of the data transmission unit D4. In detail, referring to FIG. 2F together, the processor 111 of the narrowband network base station 11 selecting the under-transmission data amount 130c is based on the fact that: the under-transmission data amount 130c has the minimum difference from a data amount capable of being transmitted by the data transmission unit D3.

Similarly, since the use of i-sub2 can minimize the waste of resources of the front-end shared subframe S-sub, and transmitting the under-transmission data amount 130c of the mobile station 13c using the data transmission unit D4 is most efficient, the processor 111 of narrowband network base station 11 may then allocate the candidate unit CU₂ and the data transmission unit D4 to the mobile station 130c via the transceiver 113.

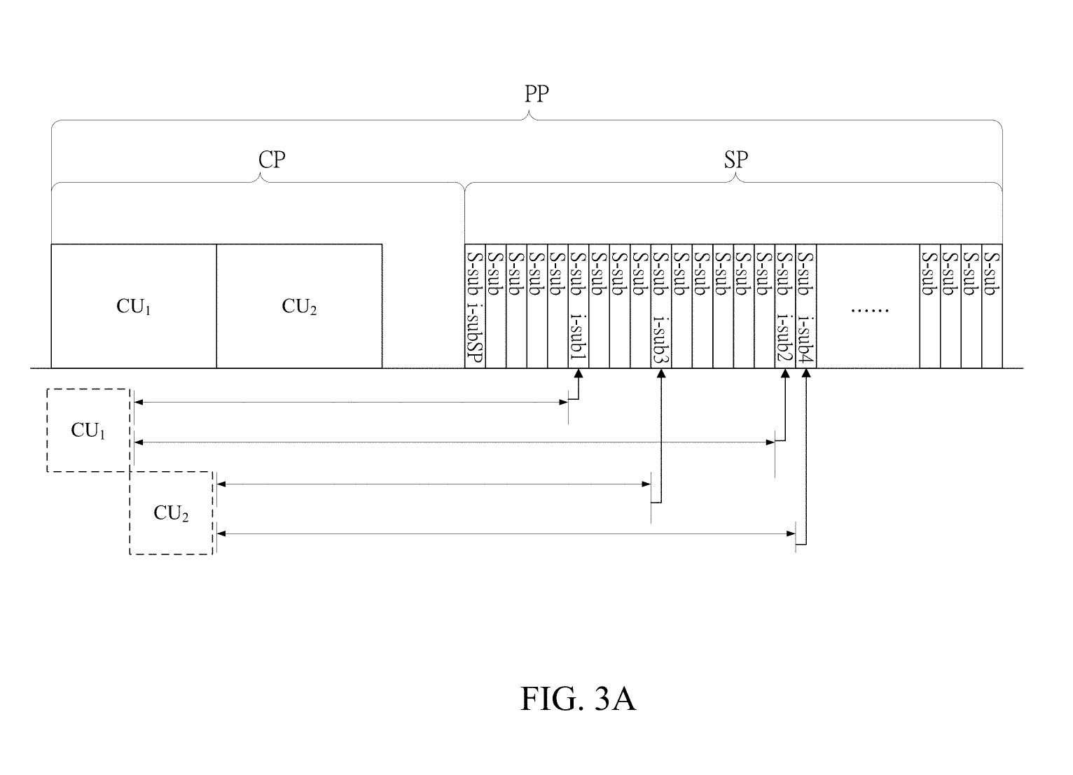

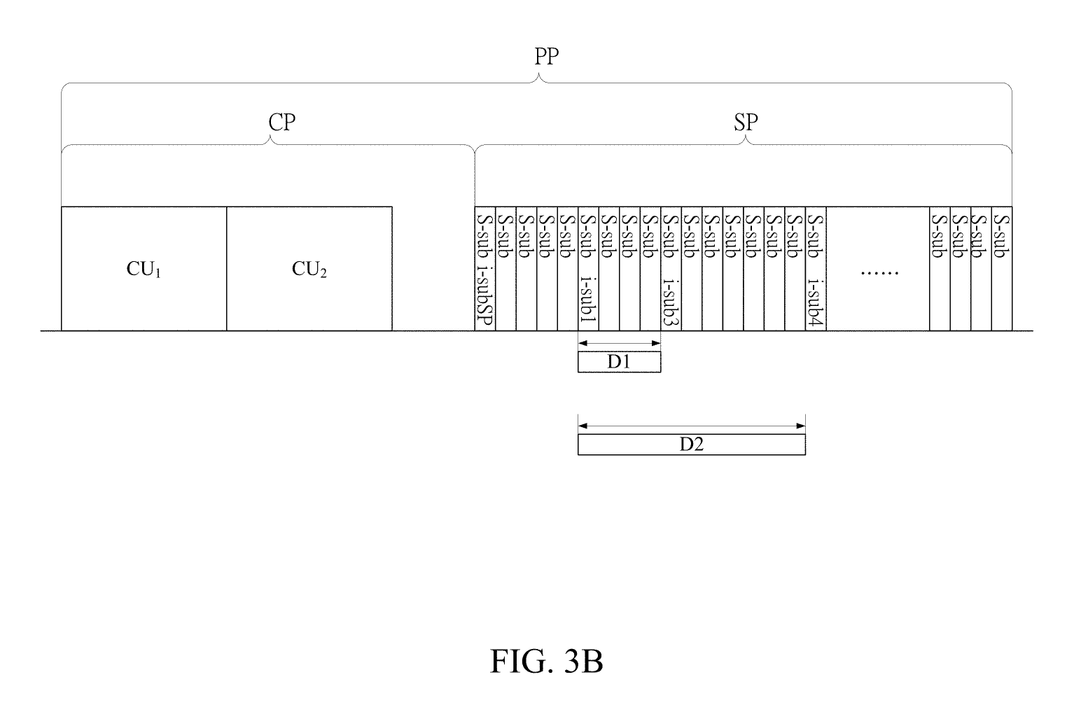

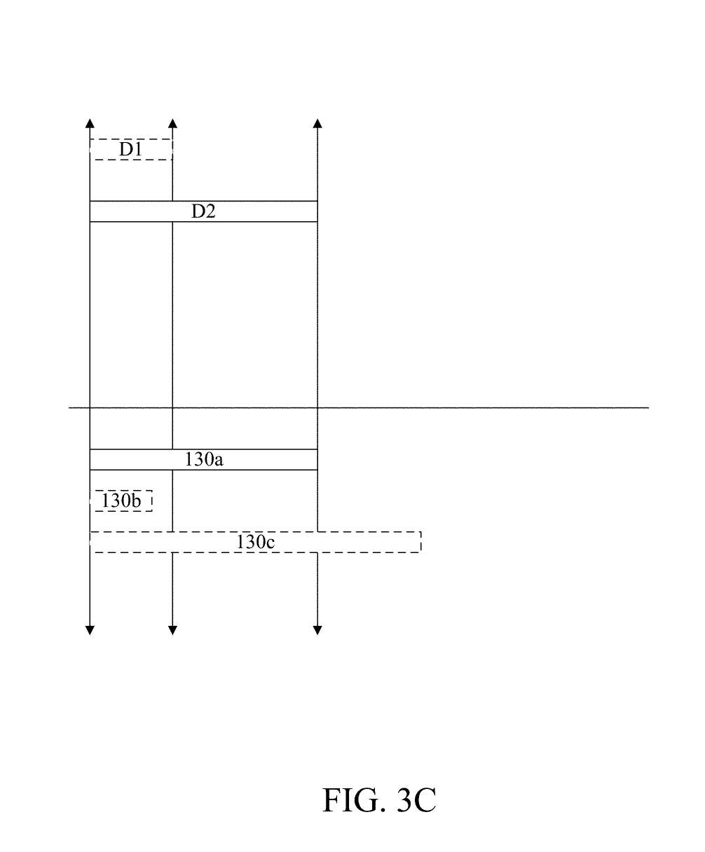

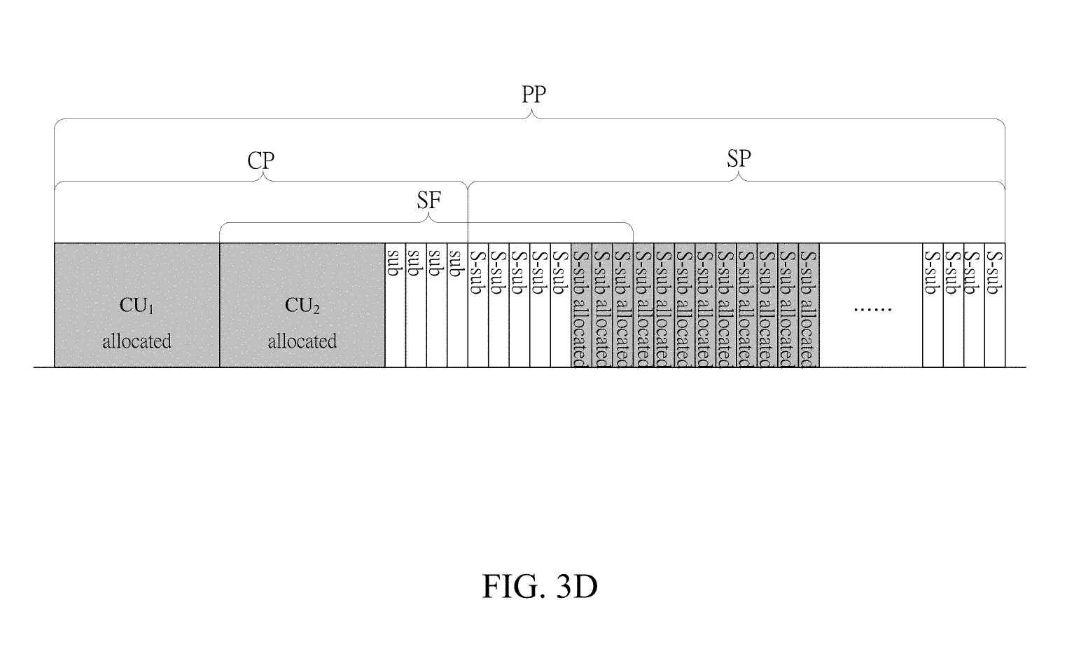

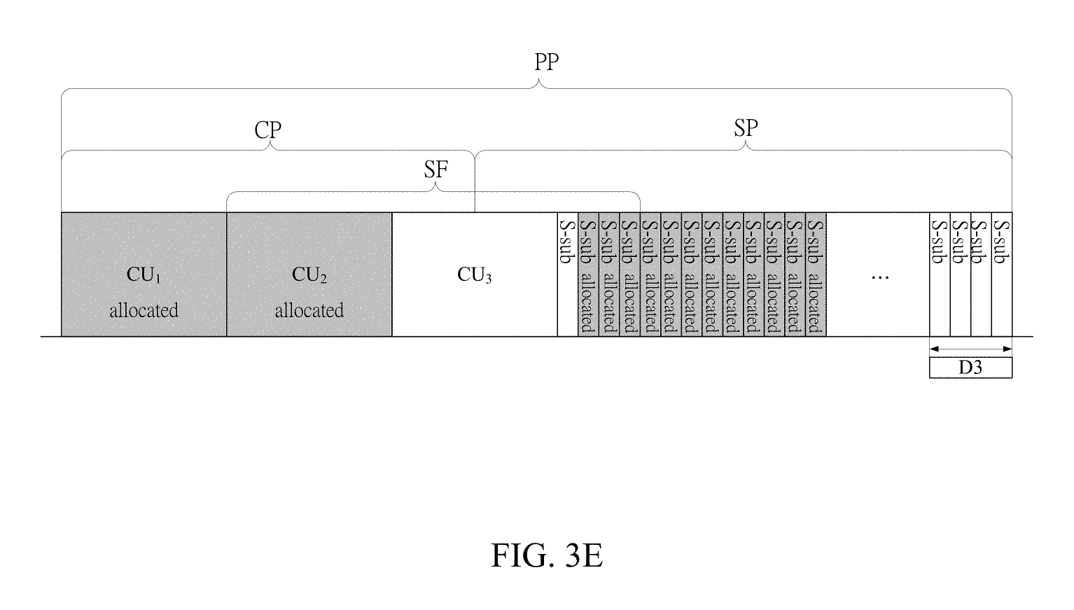

Please refer to FIG. 3A to FIG. 3E, which are schematic views illustrating the narrowband network base station 11 performing data scheduling for a data processing period PP according to a third embodiment of the present invention. The network architecture of the third embodiment is similar to those of the aforesaid embodiments, so elements with same symbols have same functions and will not be further described herein. The third embodiment mainly further illustrates details of data scheduling performed by the narrowband base station of the present invention.

First, as shown in FIG. 3A, the processor 111 of the narrowband network base station 11 first determines a plurality of shared channel initial subframes i-sub1 to i-sub4 corresponding to the candidate units CU₁ to CU₄. The candidate unit CU₁ corresponds to two shared channel initial subframes i-sub1 to i-sub2, and the candidate unit CU₂ corresponds to two shared channel initial subframes i-sub3 and i-sub4.

Next, the processor 111 of the narrowband network base station 11 selects the candidate unit CU₁ corresponding to the first shared channel initial subframe i-sub1 as the first candidate unit because the shared channel initial subframe i-sub1 has the shortest distance to the initial subframe i-subSP of the shared channel period SP. Thereafter, referring to FIG. 3B, the processor 111 of the narrowband base station 11 decides a plurality of data transmission units D1 to D2 according to a plurality of distances between the shared channel initial subframe i-sub1 of the candidate unit CU₁ and the shared channel initial subframes i-sub3 to i-sub4 of other candidate unit CU₂.

Next, the processor 111 of the narrowband base station 11 first calculates a plurality of under-transmission data amounts 130a to 130c (uplink or downlink) of a plurality of mobile stations 13a to 13c. Then, the processor 111 selects the under-transmission data amount 130a of the mobile station 13a from the under-transmission data amounts 130a to 130c according to the sizes of the data transmission units D1 to D2.

In detail, referring to FIG. 3C together, the processor 111 of the narrowband network base station 11 selecting the under-transmission data amount 130a is based on the fact that: the under-transmission data amount 130a has the minimum difference from a data amount capable of being transmitted by the data transmission unit D2. Accordingly, the processor 111 of narrowband network base station 11 allocates the candidate unit CU₁ and the data transmission unit D2 to the mobile station 13a via the transceiver 113.

Next, in the third embodiment, if the candidate unit CU₂ and the data transmission unit corresponding to the candidate unit CU₂ have been allocated to other mobile stations via the same steps, then no candidate unit is now available in the control channel period CP, and thus the narrowband network base station 11 cannot provide resources to the mobile stations for use. However, the narrowband network base station 11 may perform adjustment by using a shift parameter (not shown) if it is further determined that there are unused network resources in the data processing period PP and there are data of the mobile stations that have not been transmitted.

Please refer to FIG. 3D together. Specifically, as shown in FIG. 3D, the processor 111 of the narrowband network base station 11 generates a shift control channel period SF within the data processing period PP according to a shift parameter. Next, the processor 111 of the narrowband network base station 11 determines that the shift control channel period SF has a plurality of continuous unused subframes, and the number of the unused subframes is greater than or equal to a candidate unit size. Then, as shown in FIG. 3E, the processor 111 of the narrowband network base station 11 accordingly allocates a supplementary candidate unit CU₃ in the unused subframes, and meanwhile decides an unused data transmission unit D3 corresponding to the supplementary candidate unit CU₃.

Thereafter, the processor 111 of the narrowband network base station 11 selects a under-transmission data amount 130b corresponding to a mobile station 13b from the under-transmission data amounts 130b and 130c according to the unused data transmission unit D3. Similarly, the processor 111 selecting the mobile station 13b is based on the fact that: the under-transmission data amount 130b has the minimum difference from a data amount capable of being transmitted by the unused data transmission unit D3.

Accordingly, the processor 111 of the narrowband network base station 11 allocates the supplementary candidate unit CU₃ and the unused data transmission unit D3 to the mobile station 13b via the transceiver 113. In this way, after all the candidate units have been used up, the narrowband network base station 11 may still integrate the remaining unused network resources for use by utilizing the shift parameter, thereby further improving the utilization ratio of network resources.

It shall be particularly noted that, in the third embodiment, the size of the shift control channel period is equal to the size of the control channel period, and the shift parameter may be ⅛, ¼ or ⅜ of the NB-IoT specification. Accordingly, the narrowband network base station decides a distance, by which the shift control channel period needs to be moved with respect to the initial point of the data processing period, based on the product of the data process period and ⅛, ¼ or ⅜. However, this is not intended to limit the implementation of the present invention.

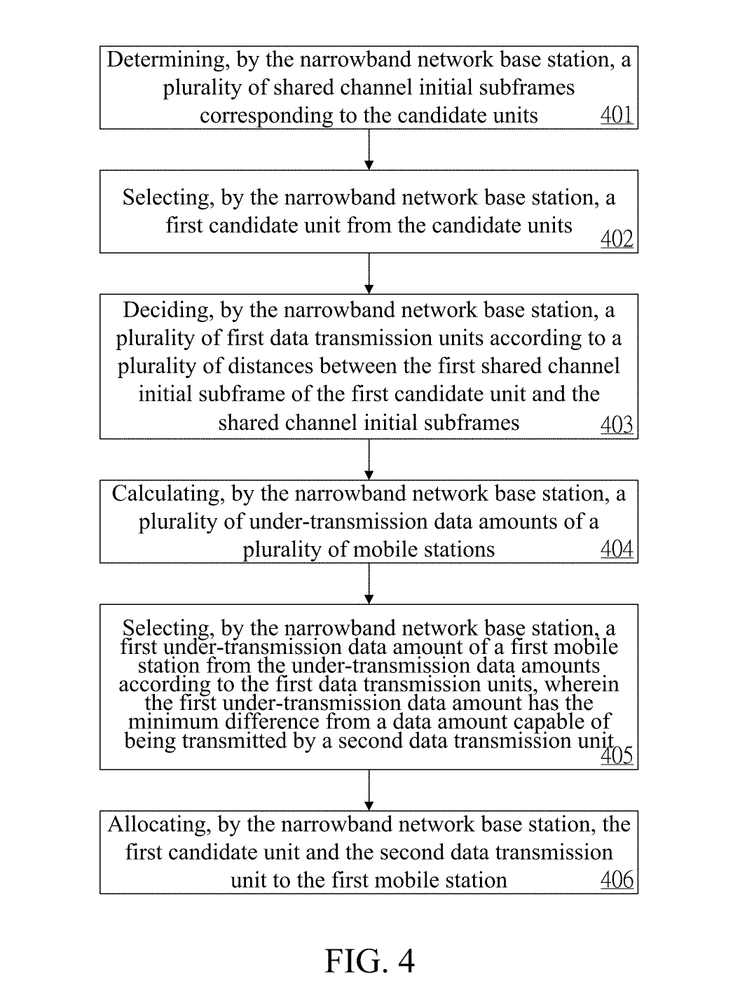

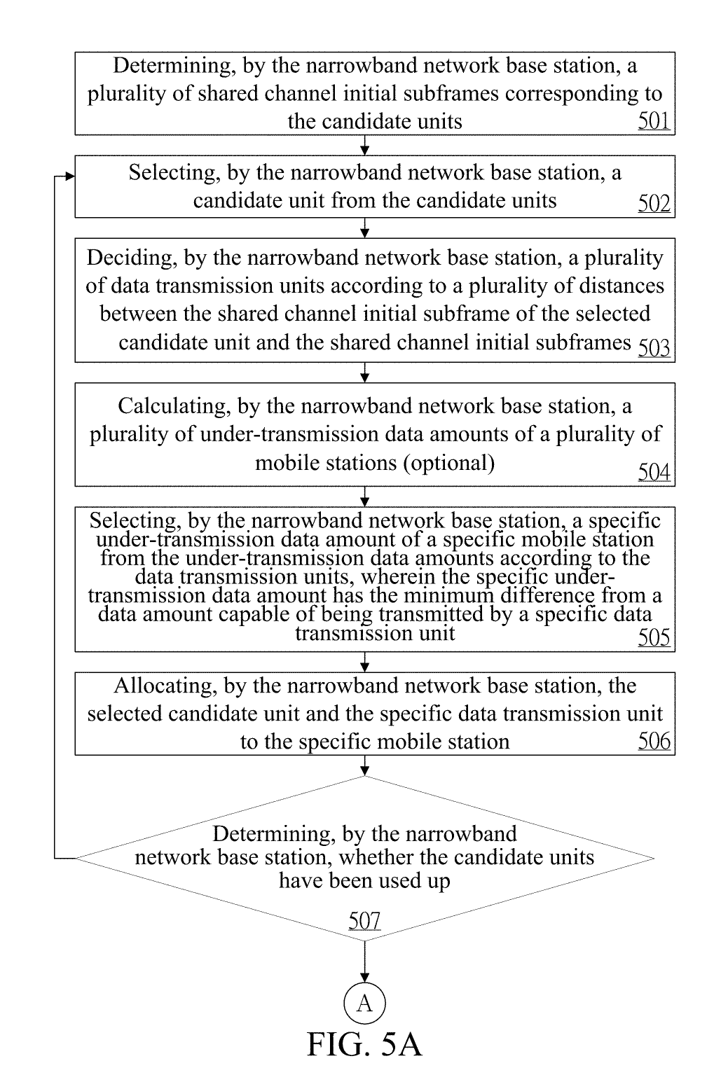

A fourth embodiment of the present invention is a mobile station data transmission scheduling method, and a flowchart diagram thereof is as shown in FIG. 4. The method of the fourth embodiment is for use in a narrowband network base station (e.g., the narrowband network base station of the aforesaid embodiments). The narrowband network base station performs data scheduling for a data processing period. The data processing period comprises a control channel period and a shared channel period. The control channel period comprises a plurality of candidate units, and the shared channel period comprises a plurality of shared channel subframes. Detailed steps of the fourth embodiment are as follows.

First, step 401 is executed to determine, by the narrowband network base station, a plurality of shared channel initial subframes corresponding to the candidate units. Step 402 is executed to select, by the narrowband network base station, a first candidate unit from the candidate units. The shared channel initial subframes include a first shared channel initial subframe corresponding to the first candidate unit, and the first shared channel initial subframe has the shortest distance to an initial subframe of the shared channel period.

Next, step 403 is executed to decide, by the narrowband network base station, a plurality of first data transmission units according to a plurality of distances between the first shared channel initial subframe and the shared channel initial subframes. Step 404 is executed to calculate, by the narrowband network base station, a plurality of under-transmission data amounts of a plurality of mobile stations.

Step 405 is executed to select, by the narrowband network base station, a first under-transmission data amount of a first mobile station from the under-transmission data amounts according to the first data transmission units. The first under-transmission data amount has the minimum difference from a data amount capable of being transmitted by a second data transmission unit among the plurality of first data transmission units. Finally, step 406 is executed to allocate, by the narrowband network base station, the first candidate unit and the second data transmission unit to the first mobile station.

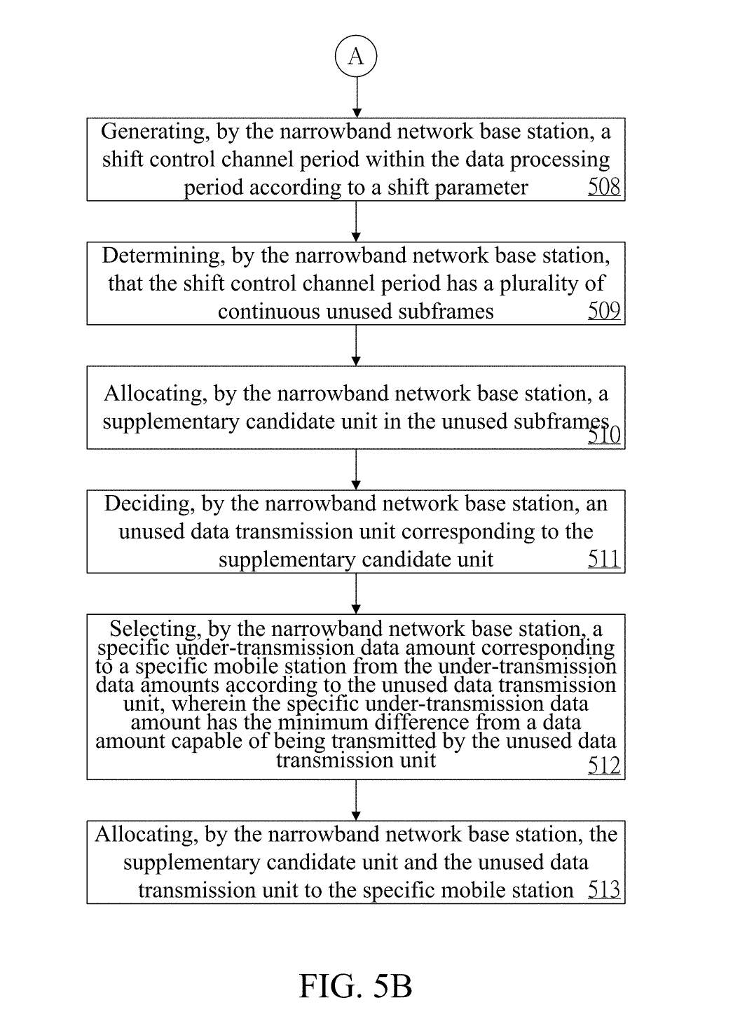

A fifth embodiment of the present invention is a mobile station data transmission scheduling method, and a flowchart diagram thereof is as shown in FIG. 5A to FIG. 5B. The method of the fifth embodiment is for use in a narrowband network base station (e.g., the narrowband network base station of the aforesaid embodiments). The narrowband network base station performs data scheduling for a data processing period. The data processing period comprises a control channel period and a shared channel period. The control channel period comprises a plurality of candidate units, and the shared channel period comprises a plurality of shared channel subframes. Detailed steps of the fifth embodiment are as follows.

First, step 501 is executed to determine, by the narrowband network base station, a plurality of shared channel initial subframes corresponding to the candidate units. Step 502 is executed to select, by the narrowband network base station, a candidate unit from the candidate units. The shared channel initial subframes include a shared channel initial subframe corresponding to the selected candidate unit, and the shared channel initial subframe of the selected candidate unit has the shortest distance to an unallocated initial subframe of the shared channel period.

Next, step 503 is executed to decide, by the narrowband network base station, a plurality of data transmission units according to a plurality of distances between the shared channel initial subframe of the selected candidate unit and the shared channel initial subframes. Step 504 is executed to calculate, by the narrowband network base station, a plurality of under-transmission data amounts of a plurality of mobile stations.

Step 505 is executed to select, by the narrowband network base station, a specific under-transmission data amount of a specific mobile station from the under-transmission data amounts according to the data transmission units. The specific under-transmission data amount has the minimum difference from a data amount capable of being transmitted by a specific data transmission unit among the plurality of first data transmission units. Finally, step 506 is executed to allocate, by the narrowband network base station, the selected candidate unit and the specific data transmission unit to the specific mobile station.

Next, step 507 is executed to determine, by the narrowband network base station, whether the candidate units have been used up. If the determination result is no, then the step 502 is executed to repeat the relevant steps. It shall be particularly noted that, the un-transmission data of the mobile stations have been calculated in the first round, so the step 504 may be omitted in the subsequent round.

On the other hand, if the narrowband base station determines that the candidate units have been used up, then step 508 is executed to generate, by the narrowband network base station, a shift control channel period within the data processing period according to a shift parameter. Step 509 is executed to determine, by the narrowband network base station, that the shift control channel period has a plurality of continuous unused subframes. The number of the unused subframes is greater than or equal to a candidate unit size. Step 510 is executed to allocate, by the narrowband network base station, a supplementary candidate unit in the unused subframes. Step 511 is executed to decide, by the narrowband network base station, an unused data transmission unit corresponding to the supplementary candidate unit.

Next, step 512 is executed to select, by the narrowband network base station, a specific under-transmission data amount corresponding to a specific mobile station from the under-transmission data amounts according to the unused data transmission unit. The specific under-transmission data amount has the minimum difference from a data amount capable of being transmitted by the unused data transmission unit. Step 513 is executed to allocate, by the narrowband network base station, the supplementary candidate unit and the unused data transmission unit to the specific mobile station.

It shall be particularly noted that, in the aforesaid embodiments, the mobile station and the under-transmission data amount thereof may be selected based on the principle that “the under-transmission data amount of the mobile station is smaller than or equal to the data amount capable of being transmitted by any data transmission unit”. In this way, the under-transmission data of the mobile station can be completely transmitted in one data processing period.

However, in other implementations, if the under-transmission data mount of each of all the mobile stations is greater than the data transmission capable of being transmitted by any of all the data transmission units, then the under-transmission data of a most suitable mobile station (i.e., the under-transmission data having the minimum difference from the data transmission unit) may be divided into two parts, and a data amount of one of the two parts is equal to the data amount capable of being transmitted by the data transmission unit, while the remaining part of data may be transmitted in the next data processing period.

According to the above descriptions, the narrowband network base station and the mobile station data transmission scheduling method thereof according to the present invention optimize the utilization of network resources by performing allocation after performing determination in advance, and may further make use of unused resources through the shift parameter. In this way, the utilization ratio of the narrowband network resources can be improved remarkably, and meanwhile the problem of a poor utilization ratio of network resources in the prior art can be effectively solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile station data transmission scheduling method for a narrowband network base station, the narrowband network base station performing data scheduling for a data processing period, the data processing period comprising a control channel period and a shared channel period, the control channel period comprising a plurality of candidate units, and the shared channel period comprising a plurality of shared channel subframes, the mobile station data transmission scheduling method comprising:
determining, by the narrowband network base station, a plurality of shared channel initial subframes corresponding to the candidate units;
selecting, by the narrowband network base station, a first candidate unit from the candidate units, wherein the shared channel initial subframes include a first shared channel initial subframe corresponding to the first candidate unit, and the first shared channel initial subframe has the shortest distance to an initial subframe of the shared channel period;
deciding, by the narrowband network base station, a plurality of first data transmission units according to a plurality of distances between the first shared channel initial subframe and the shared channel initial subframes;
calculating, by the narrowband network base station, a plurality of under-transmission data amounts of a plurality of mobile stations;
selecting, by the narrowband network base station, a first under-transmission data amount of a first mobile station from the under-transmission data amounts according to the first data transmission units, wherein the first under-transmission data amount has the minimum difference from a data amount capable of being transmitted by a second data transmission unit among the plurality of first data transmission units; and
allocating, by the narrowband network base station, the first candidate unit and the second data transmission unit to the first mobile station.

2. The mobile station data transmission scheduling method of claim 1, further comprising:
generating, by the narrowband network base station, a shift control channel period within the data processing period according to a shift parameter;
determining, by the narrowband network base station, that the shift control channel period has a plurality of continuous unused subframes, wherein the number of the unused subframes is greater than or equal to a candidate unit size;
allocating, by the narrowband network base station, a supplementary candidate unit in the unused subframes;
deciding, by the narrowband network base station, an unused data transmission unit corresponding to the supplementary candidate unit;
selecting, by the narrowband network base station, a third under-transmission data amount corresponding to a third mobile station from the under-transmission data amounts according to the unused data transmission unit, wherein the third under-transmission data amount has the minimum difference from a data amount capable of being transmitted by the unused data transmission unit; and
allocating, by the narrowband network base station, the supplementary candidate unit and the unused data transmission unit to the third mobile station.

3. The mobile station data transmission scheduling method of claim 1, further comprising:
selecting, by the narrowband network base station, a second candidate unit from the candidate units, wherein the shared channel initial subframes include a second shared channel initial subframe corresponding to the second candidate unit, and the second shared channel initial subframe has the shortest distance to an end subframe of the second data transmission unit;
deciding, by the narrowband network base station, a plurality of third data transmission units according to a plurality of distances between the second shared channel initial subframe and the shared channel initial subframes;
selecting, by the narrowband network base station, a second under-transmission data amount corresponding to a second mobile station from the under-transmission data amounts according to the data transmission units, wherein the second under-transmission data amount has the minimum difference from a data amount capable of being transmitted by a fourth data transmission unit among the data transmission units; and
allocating, by the narrowband network base station, the second candidate unit and the fourth data transmission unit to the second mobile station.

4. The mobile station data transmission scheduling method of claim 1, wherein the narrowband network base station determines the shared channel initial subframes corresponding to the candidate units according to a plurality of schedule delay parameter values, and each of the candidate units and each of the schedule delay parameter values correspond to one of the shared channel initial subframes.

5. The mobile station data transmission scheduling method of claim 1, wherein the narrowband network base station calculates each of the under-transmission data amounts according to the under-transmission data and the number of re-transmissions of each of the mobile stations.

6. The mobile station data transmission scheduling method of claim 1, wherein the first under-transmission data amount is less than or equal to the data amount capable of being transmitted by the second data transmission unit.

7. The mobile station data transmission scheduling method of claim 1, wherein the first under-transmission data mount is greater than the data transmission capable of being transmitted by the second data transmission unit, and the narrowband network base station is further configured to divide the first under-transmission data into two parts, with a data amount of one of the two parts being equal to the data amount capable of being transmitted by the second data transmission unit.

8. A narrowband network base station that performs data scheduling for a data processing period, the data processing period comprising a control channel period and a shared channel period, the control channel period comprising a plurality of candidate units, and the shared channel period comprising a plurality of shared channel subframes, the narrowband network base station comprising:
a processor; and
a transceiver;
wherein the processor is configured to:
determine a plurality of shared channel initial subframes corresponding to the candidate units;
select a first candidate unit from the candidate units, wherein the shared channel initial subframes include a first shared channel initial subframe corresponding to the first candidate unit, and the first shared channel initial subframe has the shortest distance to an initial subframe of the shared channel period;
decide a plurality of first data transmission units according to a plurality of distances between the first shared channel initial subframe and the shared channel initial subframes;
calculate a plurality of under-transmission data amounts of a plurality of mobile stations;
select a first under-transmission data amount of a first mobile station from the under-transmission data amounts according to the first data transmission units, wherein the first under-transmission data amount has the minimum difference from a data amount capable of being transmitted by a second data transmission unit among the plurality of first data transmission units; and
allocate the first candidate unit and the second data transmission unit to the first mobile station via the transceiver.

9. The narrowband network base station of claim 8, wherein the processor is further configured to:
generate a shift control channel period within the data processing period according to a shift parameter;
determine that the shift control channel period has a plurality of continuous unused subframes, wherein the number of the unused subframes is greater than or equal to a candidate unit size;
allocate a supplementary candidate unit in the unused subframes;
decide an unused data transmission unit corresponding to the supplementary candidate unit;
select a third under-transmission data amount corresponding to a third mobile station from the under-transmission data amounts according to the unused data transmission unit, wherein the third under-transmission data amount has the minimum difference from a data amount capable of being transmitted by the unused data transmission unit; and
allocate the supplementary candidate unit and the unused data transmission unit to the third mobile station via the transceiver.

10. The narrowband network base station of claim 8, wherein the processor is further configured to:
select a second candidate unit from the candidate units, wherein the shared channel initial subframes include a second shared channel initial subframe corresponding to the second candidate unit, and the second shared channel initial subframe has the shortest distance to an end subframe of the second data transmission unit;
decide a plurality of third data transmission units according to a plurality of distances between the second shared channel initial subframe and the shared channel initial subframes;
select a second under-transmission data amount corresponding to a second mobile station from the under-transmission data amounts according to the data transmission units, wherein the second under-transmission data amount has the minimum difference from a data amount capable of being transmitted by a fourth data transmission unit among the data transmission units; and
allocate the second candidate unit and the fourth data transmission unit to the second mobile station via the transceiver.

11. The narrowband network base station of claim 8, wherein the processor is further configured to determine the shared channel initial subframes corresponding to the candidate units according to a plurality of schedule delay parameter values, and each of the candidate units and each of the schedule delay parameter values correspond to one of the shared channel initial subframes.

12. The narrowband network base station of claim 8, wherein the processor is further configured to calculate each of the under-transmission data amounts according to the under-transmission data and the number of re-transmissions of each of the mobile stations.

13. The narrowband network base station of claim 8, wherein the first under-transmission data amount is less than or equal to the data amount capable of being transmitted by the second data transmission unit.

14. The narrowband network base station of claim 8, wherein the first under-transmission data mount is greater than the data transmission capable of being transmitted by the second data transmission unit, and the processor is further configured to divide the first under-transmission data into two parts, with a data amount of one of the two parts being equal to the data amount capable of being transmitted by the second data transmission unit.
